(19) United States
(12) Patent Application Publication
(10) Pub. No.: US 2026/0091399 A1
(43) Pub. Date: Apr. 2, 2026

(54) UNIFORM FLOW SHOWERHEAD

(71) Applicant: Malco, LLC, Coarsegold, CA (US)

(72) Inventor: David B. Malcolm, Coarsegold, CA (US)

(73) Assignee: Malco, LLC, Coarsegold, CA (US)

(21) Appl. No.: 18/900,475

(22) Filed: Sep. 27, 2024

(51) Int. Cl. B05B 1/34

(52) U.S. Cl. CPC B05B 1/34

(57) ABSTRACT

A showerhead nozzle and shroud combination that eliminates fine mist from water flow while ensuring a uniform distribution of large water droplets. The showerhead may include a uniquely-shaped single nozzle opening that generates turbulence to create a uniform spray of large droplets. The shroud may include two chambers in which the exit from the second chamber includes a non-chamfered inside edge that prevents the formation of fine mist as fluid flow through. The combination of these features improves water efficiency, reduces clogging, and enhances the user experience. In some embodiments, the showerhead may also incorporate a mirror positioned near the shroud, which is less prone to fogging due to the elimination of fine mist. This design may provide a multifunctional solution for both showering and grooming tasks, ensuring consistent water flow and ease of use.

### FIELD OF THE INVENTION

The present invention relates to showerhead technologies and water flow control systems, and more particularly to methods and apparatus for providing a uniform distribution of large, rain-like high energy water droplets from a single opening in a showerhead assembly while minimizing fine mist. Embodiments of the invention include showerhead assemblies with integrated mirrors for enhanced functionality during grooming activities.

### BACKGROUND OF THE INVENTION

Showerheads provide a convenient method for dispersing water for personal hygiene. However, many conventional showerheads suffer from the drawbacks of distributing water droplets in undesirable non-uniform patterns and of producing unwanted fine mist. Non-uniform distribution of water droplets leads to inefficiencies and frustrations during showering; and fine mist particles do not contribute to an efficient or pleasurable shower experience because they lack the mass required to provide the desired rinsing effect. Fine mist particles also tend to come to rest on surfaces inside and outside of a shower stall, resulting in slippery and potentially dangerous surfaces, and leaving mineral deposits or other residue if not wiped off after showering. Fine mist also evaporates quickly which lowers the temperature of the air around the spray.

Prior attempts have been made to address this issue by altering the design of showerhead nozzles, but these efforts have not been entirely successful. For example, one could remove the showerhead entirely and allow water to flow directly from the pipe, which effectively eliminates fine mist but fails to provide the larger, uniform droplets needed for a proper shower. This pipe flow is akin to a hose—with a smooth directed flow, but without the nozzle(s) required to create a sufficiently wide spray for showering, leading to poor distribution and unsatisfactory showering performance.

Other previous designs have sought to provide uniformly spaced nozzles to produce many laminar streams of water that spread out the water for showering. However, the small openings in these designs have issues with clogging over time, especially in areas with hard or mineral-rich water. Fine debris can accumulate in these smaller orifices, reducing water flow, producing inconsistent shower droplets, and requiring frequent maintenance. Additionally, the laminar streams have proven to feel stingy at reduced flow rates typical of modern shower heads. While some nozzles have included methods for increasing turbulence, such as spinning structures, multiple jets or complex flow paths, these solutions have not successfully addressed the challenge of producing large, uniform droplets while minimizing fine mist.

It is therefore desirable to provide a showerhead assembly that is capable of providing a uniform distribution of large water droplets while at the same time minimizing the production of unwanted fine mist, especially at low water pressures (e.g., 10-15 psi).

### SUMMARY OF THE INVENTION

Embodiments of the present invention are designed to provide a showerhead nozzle and shroud combination that are specially adapted to eliminate unwanted fine mist from the water flow exiting the showerhead, while also providing a uniform distribution of desirable larger water droplets using a single opening. These results are accomplished by providing a showerhead nozzle having a uniquely-shaped single opening that creates a uniform spray of atomized water droplets by colliding two streams together for the purpose of creating extreme turbulence, and by providing a nozzle shroud that has a sharp, unchamfered downstream edge that transforms the atomized spray into a wide and uniform spray of much larger droplets ideal for showering yet without the halo mist of small droplets associated with other attempts to produce a similar spray.

In embodiments of the nozzle of the present invention, a single opening is provided in a hollow dome located at the downstream end of a nozzle body. The dome has an ellipsoid shape as opposed to a purely spherical shape, such that the dome is flattened in the middle. The opening in the dome has a generally elliptical shape with pointed ends and a wide central area. The opening extends across the hollow ellipsoid dome portion of the nozzle from a point at one edge of the dome to another point at the opposite edge of the dome, leaving two generally concave portions of the dome, one on either side of the opening. The two generally concave portions of the dome may be complementary mirror images of each other, and may curve towards each other with the opening separating them. The first and second portions of the dome are only generally concave because they are flattened near the wide central section of the opening according to the ellipsoid shape of the dome. A pin is provided across the nozzle body below and in alignment with the opening.

Embodiments of the invention also include a should that is fitted over the nozzle body. The shroud may include a first hollow cylindrical chamber that engages the nozzle body and extends out from the downstream end of the nozzle body, and a second hollow cylindrical chamber that is wider than the first chamber, and extends further out from the first chamber. The first chamber has a diameter that is approximately the same size as the nozzle body; the second chamber has a wider diameter. The annular shoulder between the first and second chambers of the shroud may be chamfered. However, the inside edge of the downstream end of the second chamber of the shroud should have a non-chamfered ninety-degree shoulder. Chamfered edges, common in conventional designs, may disrupt water flow and contribute to the formation of fine mist by allowing small droplets to break off from the main stream. The present invention eliminates the chamfer at the end of the second chamber of the shroud, which ensures a smoother exit for the water and further promotes the formation of large droplets. The non-chamfered edge may be operable to prevent the creation of fine mist, addressing a long-standing issue in previous showerhead designs and may ensure that water flow remains smooth and effective for larger droplets, thereby improving the overall functionality of the showerhead.

As described more fully below, the generally elliptical shape of the opening, the pin below the opening, and the flattened ellipsoid shapes of the first and second portions of the dome on either side of the opening create turbulence in the water flowing through the opening that provides atomization of water droplets, even at low flow rates. The atomized water droplets exit through the opening into a first chamber in the shroud where they are compressed. As these compressed droplets travel from the first to the second chamber they expand. This expansion may be improved if the shoulder between the first and second chambers is chamfered. These droplets then exit from the second chamber having a non-chamfered inside shoulder forming a uniform cone-shaped flow. The elimination of the chamfer from this shoulder greatly reduces the production of fine mist as the water rapidly expands into a full cone spray of water droplets. These large water droplets enhance the showering experience and ensure more consistent water flow compared to fine mist, which may be less effective for rinsing. The large orifice also minimizes the risk of clogging, a common issue in showerheads with multiple smaller nozzles, making the present invention more durable and easier to maintain.

Water or other fluid flowing into the nozzle exits through the opening. The pin in the nozzle body along with the ellipsoid shape of the first and second portions of the dome in conjunction with the pointed elliptical shape of the opening results in significant turbulence in the water exiting through the nozzle. The incoming water comes into direct contact with either the pin, or the inside surfaces of the first and second portions of the ellipsoid dome, causing the water to be deflected toward the center, creating turbulence and breaking the water into atomized droplets. Because the first and second portions of the dome are flattened near the center, the water impacting the dome on one side of the opening is directed across the opening. Similarly, water impacting the dome on the other side of the opening is also directed across the opening. The deflected water from each side of the opening therefore collides with the deflected water from the other side of the opening creating turbulence and atomized water.

By flattening the top of the dome, the collision of the two streams of water results in significant atomization of the water. The atomized water then flows into the first chamber of the nozzle shroud where it is compressed. As the droplets exit into the second chamber of the shroud, they rapidly expand. Then, as they exit from the second chamber, they form into a uniform cone shape spray of rain like drops, with the non-chamfered edge of the shroud minimizing the creation of fine mist. It is to be appreciated that diameter of the spray exiting from the shroud is determined by the shroud length and its internal diameter. By increasing the internal diameter of the exit chamber, the exiting spray remains cone shaped and uniform, but also increases in diameter in relation to the increase of the internal diameter of the shroud.

In embodiments of the invention, the combination of the uniquely-shaped nozzle and the two-chamber shroud with non-chamfered exit shoulder may result in a showerhead that offers several key advantages. First, it may be operable to deliver a uniform distribution of large water droplets, which may enhance both the effectiveness and enjoyment of the showering experience. The mass of these larger droplets may ensure they reach the skin with sufficient force to provide a thorough rinse. Second, the design may minimize the formation of fine mist, promoting a cleaner and more efficient use of water while reducing airborne moisture that may contribute to bathroom fogging. Third, the single large nozzle may reduce the risk of clogging, ensuring consistent water flow over time and minimizing the need for maintenance. Finally, all of these advantages may be achieved with low water pressures (e.g., 10-15 psi).

In some embodiments, the shower head may include a mirror as part of or near the shroud. Since the formation of fine mist may be minimized, the mirror may be placed closer to the water flow without fogging as quickly as it would with conventional designs and may add value to the showerhead by allowing users to incorporate grooming tasks, such as shaving, directly into their shower routine. The mirror feature, coupled with the enhanced water flow characteristics, distinguishes the present invention as a multifunctional device that improves both water efficiency and user convenience.

It is an aspect of the present invention to provide a showerhead that not only improves water flow but also addresses several critical issues in traditional designs, such as mist elimination and clog prevention. The unique nozzle and shroud combination ensures uniform water droplet distribution and smooth flow, while the larger nozzle opening reduces the risk of clogging. This makes the invention highly durable and reliable, suitable for long-term use without frequent maintenance. Additionally, the ability to incorporate a mirror directly into the showerhead without the typical fogging issues adds significant functionality, making this invention a comprehensive solution for improving the shower experience.

In another aspect, a combination showerhead nozzle and shroud assembly is provided that comprises a hollow cylindrical nozzle body having a diameter, an open upstream end, and a hollow dome at an opposite downstream end, the dome having a flattened ellipsoid shape; an opening extending across said dome, the opening having a generally elliptical shape; a pin extending across said nozzle body below and in parallel with said opening; a hollow cylindrical shroud operable for engagement with the downstream end of said nozzle body, with the shroud comprising: a first cylindrical chamber adjacent to said nozzle body and extending downstream therefrom, with the first chamber having a diameter that corresponds to the diameter of said nozzle body, a second cylindrical chamber adjacent to said first chamber and extending downstream therefrom to an open end, with the second chamber having a diameter that is wider than the diameter of the first chamber, an annular chamfered shoulder between said first chamber and said second chamber, and a second non-chamfered annular shoulder on an inside edge of the open end of the second chamber.

In related aspects, the second shoulder has a ninety degree cross section. In other aspects, the opening further comprise a first pointed end at one edge of the dome, and a second pointed end at an opposite edge of the dome, and wherein the opening has a wide central area. In related aspects, the shroud further comprises a mirror.

In another aspect, a combination showerhead nozzle and shroud assembly is provided that comprises a nozzle body having an upstream end and a downstream end; a flow passage disposed in said nozzle body, with the flow passage having an inlet generally towards said upstream end and an elliptical outlet at said downstream end, the flow passage being adapted to carry a liquid flow stream; a pin extending across the nozzle body in parallel with said elliptical outlet; a first flange defining a first edge of said elliptical outlet, with the first flange forming a first portion of a dome having a flattened ellipsoid shape for inducing turbulence into a first portion of said liquid flow stream; a second flange defining a second edge of said elliptical outlet, with the second flange forming an opposite second portion of said dome and also having a flattened ellipsoid shape for inducing turbulence into a second portion of said liquid flow stream such that said first stream and said second stream collide together to form a substantially uniform droplet sized spray; and a hollow cylindrical shroud operable for engagement with said nozzle body such that an open end of said shroud extends out beyond the downstream end of said nozzle body, with the shroud further comprising: a first cylindrical internal chamber adjacent to the nozzle body, with the first chamber having a diameter that corresponds to the diameter of said nozzle body, a second cylindrical chamber adjacent to the first chamber and extending downstream therefrom to an open end, with the second chamber having a diameter that is wider than the diameter of the first chamber, an annular chamfered shoulder between the first chamber and the second chamber, and a second non-chamfered annular shoulder on an inside edge of the open end of the second chamber.

In related aspects, the outlet further comprises a first pointed end at a first edge of the nozzle, and a second pointed end at an opposite edge of the nozzle, and wherein the outlet has a wide central area. In other aspects, the second annular shoulder has a ninety degree cross section. On other aspects, the shroud further comprises a mirror.

It is another aspect of embodiments of the invention to provide a method for providing large droplets for showering without mist that comprises the steps of: contacting a first portion of a stream of water with the interior surface of a first curved flange of a nozzle body, with the first flange having a flattened ellipsoid shape to deflect and induce turbulence into the first portion of the stream of water; contacting a second portion of the stream of water with the interior surface of a second curved flange of the nozzle body, with the second flange having a flattened ellipsoid shape to deflect and induce turbulence into the second portion of the stream of water; contacting a third portion of the stream of water with a pin extending across said nozzle body to induce turbulence into the third portion of said stream of water; forming atomized water droplets from the collision of the first second and third deflected portions of the stream of water; passing the atomized water droplets through an elliptically shaped opening in said nozzle body, with the opening being located between the first and second flanges; passing the atomized water droplets into a first chamber of a shroud that is engaged with and downstream from the nozzle body to compress the water droplets; passing the compressed droplets into a second chamber of the shroud that is attached to the first chamber, with the second chamber having a diameter that is larger than a diameter of the first chamber to expand said droplets; and passing the expanded droplets through an end of the second chamber forming a uniform cone-shaped spray of large water droplets wherein an interior annular shoulder at the end of the second chamber has a non-chamfered surface to reduce the formation of mist.

Further aspects and embodiments will be apparent to those having skill in the art from the description and disclosure provided herein.

It is therefore an object of the invention to provide a combination nozzle and shroud showerhead assembly that provides uniform distribution of water droplets with minimal unwanted fine mist having a single large opening that is not likely to clog.

It is another object of the present invention to provide a combination nozzle and shroud showerhead assembly having a unique elliptical nozzle opening in a ellipsoidal dome located at a downstream end of the nozzle body.

It is another object of the present invention to provide a combination nozzle and shroud showerhead assembly having a shroud that includes two chambers, where the inside edge of the exit chamber is not chamfered in order to minimize the creation of fine mist.

It is another object of the present invention to provide a combination nozzle and shroud showerhead assembly that provides uniform distribution of water droplets with minimal unwanted fine mist at low water pressures (e.g. 10-15 psi).

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 is a perspective exterior view of an embodiment of a downstream end of a nozzle body of the present invention showing the elliptical opening in a dome having a flattened ellipsoid shape.

FIG. 2 is a left side view of the downstream end of the nozzle body of the present invention shown in FIG. 1.

FIG. 3 is a front view of the downstream end of the nozzle body of the present invention shown in FIG. 1.

FIG. 4 is a rear view of the downstream end of the nozzle body of the present invention shown in FIG. 1.

FIG. 5 is a right side view of the downstream end of the nozzle body of the present invention shown in FIG. 1.

FIG. 6 is a bottom (interior) view of the downstream end of the nozzle body of the present invention shown in FIG. 1.

FIG. 7 is a top (exterior) view of the downstream end of the nozzle body of the present invention shown in FIG. 1.

FIG. 8 is a rear perspective view of an embodiment of the present invention showing a showerhead assembly having a nozzle body, shroud and mirror.

FIG. 9 is a front elevational view of an embodiment of the present invention.

FIG. 9A is a sectional side view of an embodiment of the present invention along line 9A-9A of FIG. 9.

FIG. 10 is a close-up sectional side view of an embodiment of the present invention showing a nozzle body and shroud.

FIG. 11 close-up sectional side view of an embodiment of the present invention showing a flow of fluid through an embodiment of the nozzle body and shroud.

FIG. 11A is a close-up sectional side view of an embodiment of the present invention showing another flow of fluid through an embodiment of the nozzle body and shroud.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

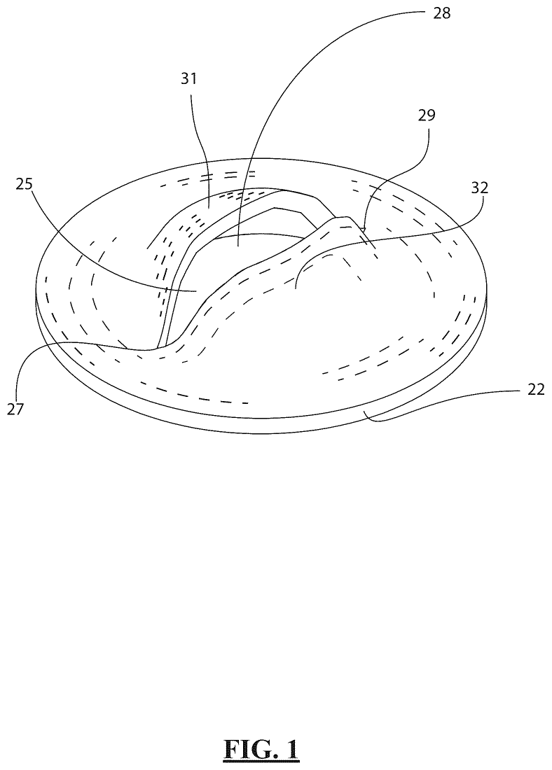

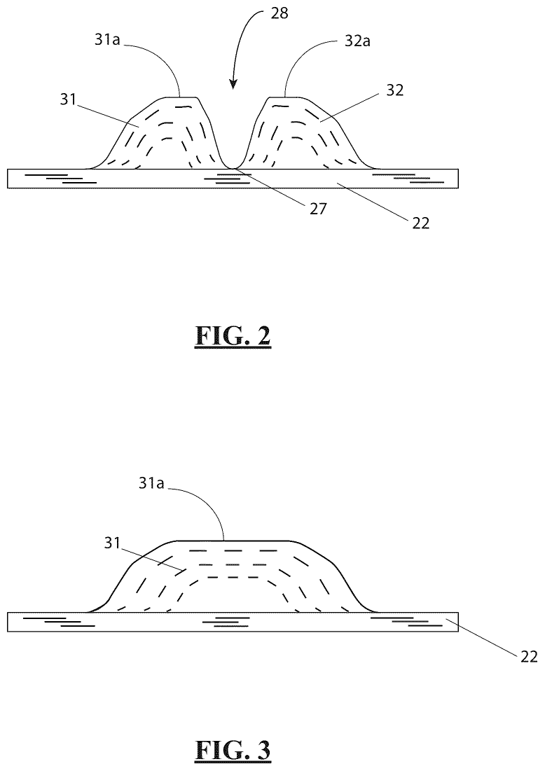

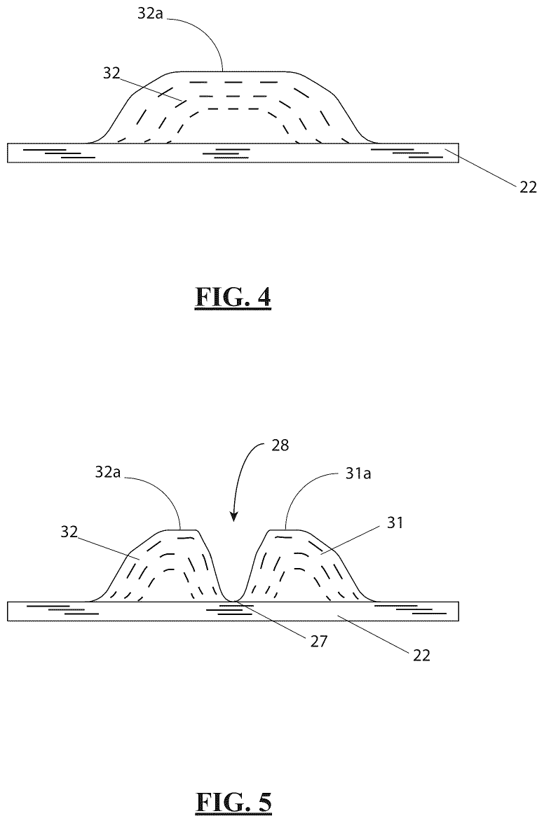

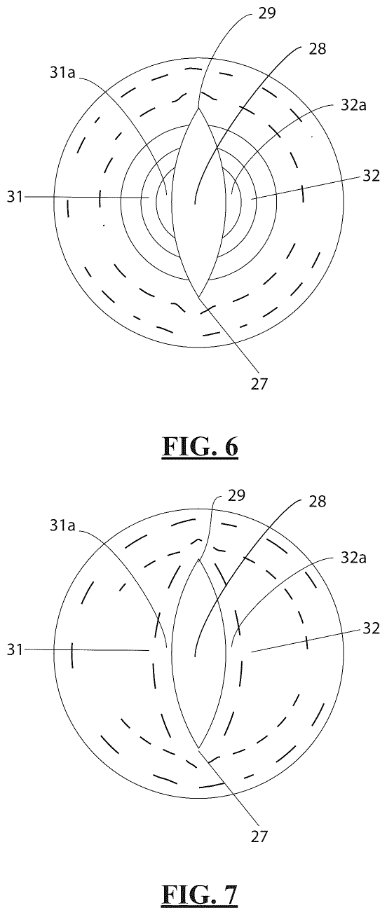

Referring to the drawings, wherein like reference characters designate like or corresponding parts throughout the several views, and referring particularly to FIGS. 1-7, it is seen that these figures depict different views of the downstream end or cap 22 of a shower nozzle body 21. A single opening 25 is provided in a flattened hollow dome on the cap 22, the opening bisecting the dome into two side portions 31, 32 that are mirror-images of each other. The dome has an ellipsoid shape such that each of the side portions 31, 32 is rounded at the base and includes a flattened area 31a, 32a, respectively, near the opening 25 at the center of the dome. The opening 25 in the dome has a generally elliptical shape with pointed ends 27, 29 and a wide central area 28. The nozzle body 21 is bisected by a pin 35 that extends across the nozzle body 21 immediately below and in parallel with opening 25.

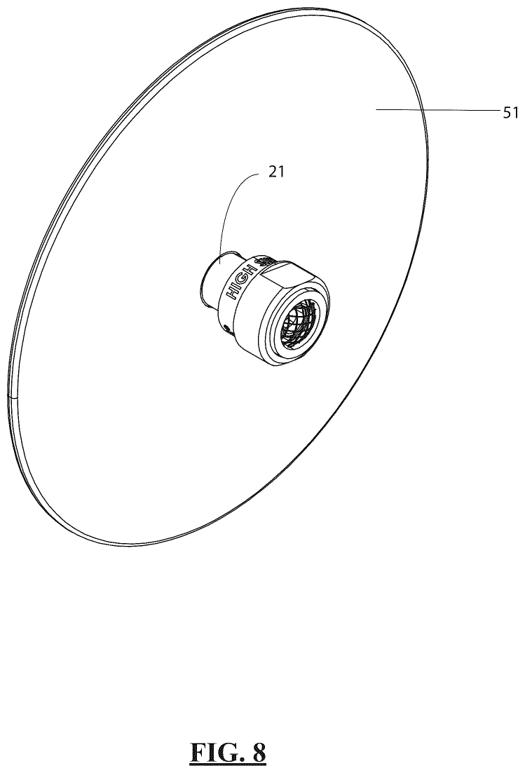

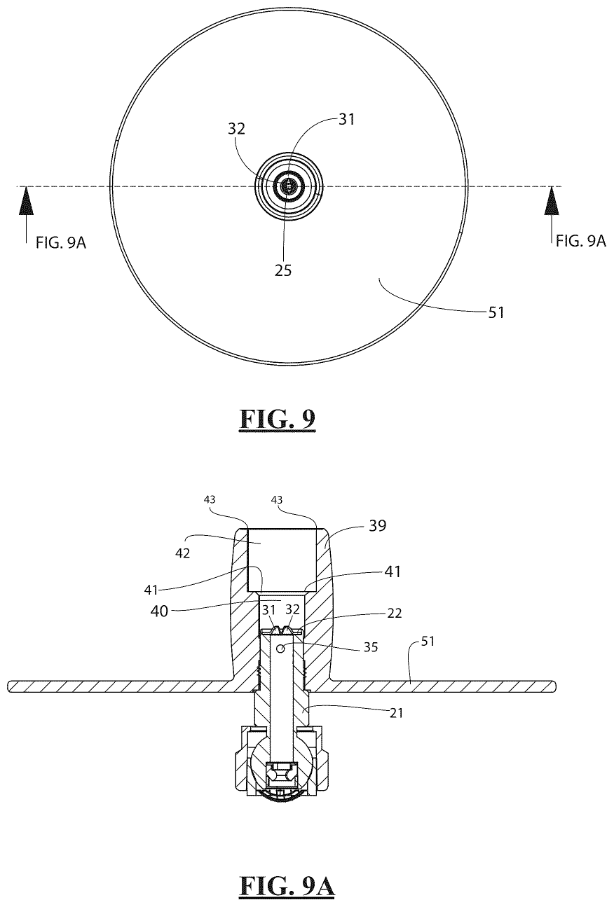

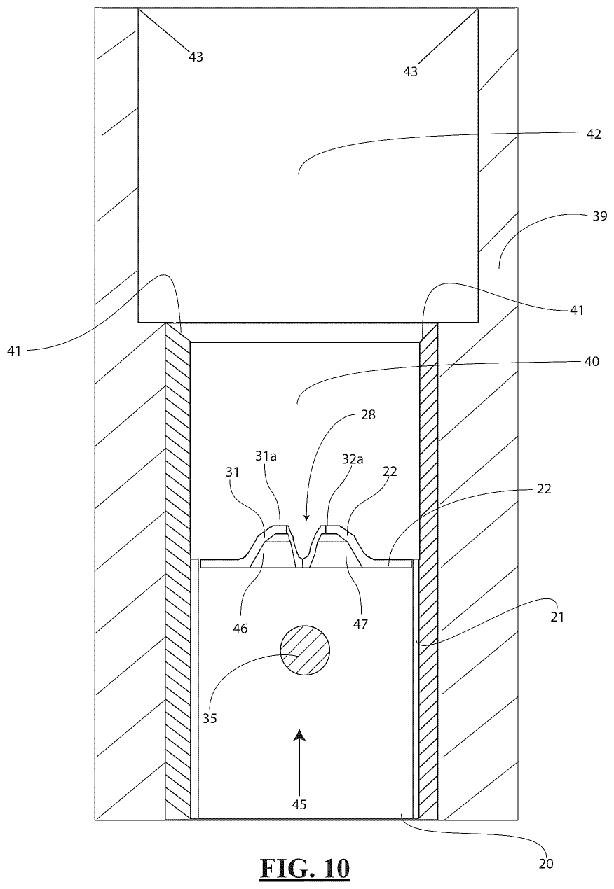

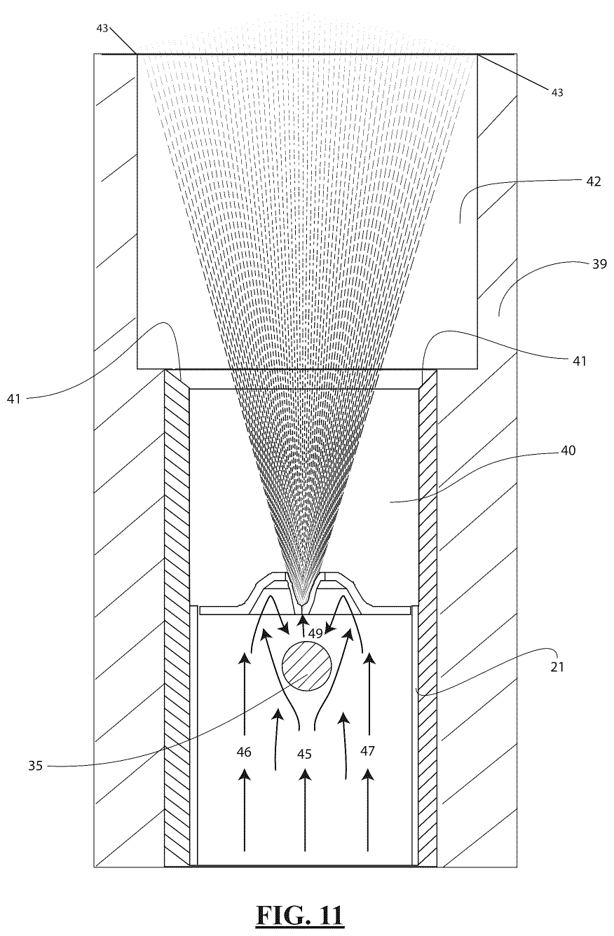

A shroud 39 is provided in embodiments of the invention having a first cylindrical central chamber 40 that engages with the nozzle body 21. Chamber 40 may have an internal diameter that is approximately the same as that of the nozzle body. A downstream portion of the first cylindrical chamber 40 of the shroud 39 extends beyond the end 22 of the nozzle body, as shown in FIGS. 9A, 10 and 11. A second cylindrical chamber 42 is provided in the shroud downstream from the first chamber 40. The second chamber has an internal diameter that is larger than the first chamber 40. An annular shoulder 41 is provided between the first and second chambers 40, 42. Shoulder 41 may be chamfered. The downstream end of the second chamber 42 also has an annular shoulder 43 at its inside edge. The cross section of this shoulder 43 should be ninety degrees, and should not be tapered or chamfered. In some embodiments, such as those shown in FIGS. 8-9, shroud 39 may include a mirror 51.

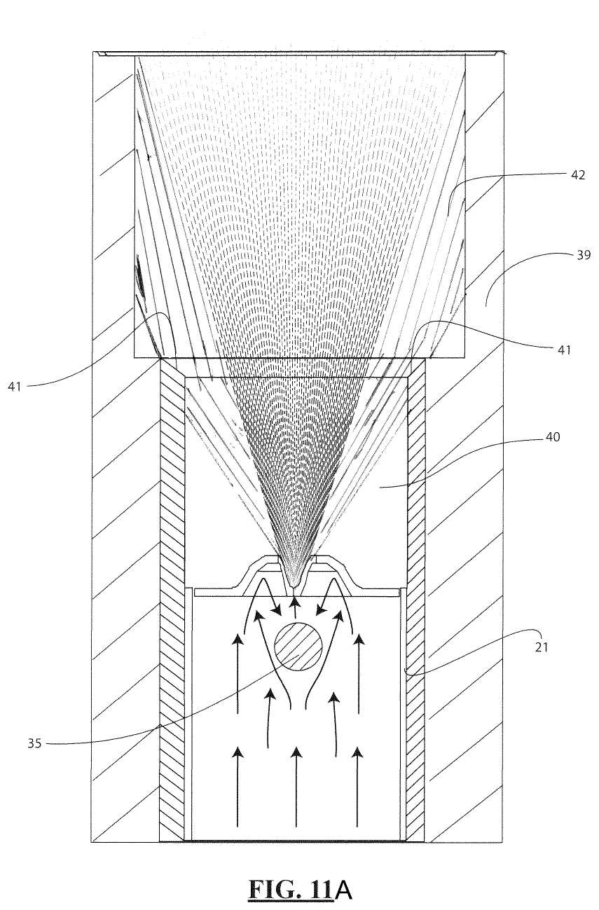

As shown in the detail of FIGS. 10 and 11, water 45 flows into nozzle body 21 from the upstream end 20. Some of this water 48 makes contact with pin 35 and is diffused to one side or the other the pin. The remaining water 45 makes contact with the interior surfaces of one of the side portions 31, 32 of the dome. Water 46 that comes into contact with first side portion 31 is deflected toward the middle of the nozzle body. Similarly, water 47 that comes into contact with second side portion 32 is also deflected toward the middle of the nozzle body. The deflected water 46 collides with deflected water 47, and with water deflected from pin 35 underneath opening 25 resulting in considerable turbulence and atomization of the water particles 49 above pin 35.

The atomized water 49 then flows into the first chamber 40 of the nozzle shroud 39 where they are compressed. As the droplets exit from the first chamber 40 to the second chamber 42 of the shroud, they rapidly expand. The non-chamfered interior edge 42 at the exit of the second shroud chamber 42 minimizes the creation of fine mist, resulting in a uniform cone-shaped distribution of large water droplets that are ideal for showering.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A combination showerhead nozzle and shroud comprising:
a. a hollow cylindrical nozzle body having a diameter, an open upstream end, and a hollow dome at an opposite downstream end, the dome having a flattened ellipsoid shape;
b. an opening extending across said dome, the opening having a generally elliptical shape;
c. a pin extending across said nozzle body below and in parallel with said opening;
d. a hollow cylindrical shroud operable for engagement with the downstream end of said nozzle body, said shroud comprising:
i. a first cylindrical chamber adjacent to said nozzle body and extending downstream therefrom, said first chamber having a diameter that corresponds to the diameter of said nozzle body,
ii. a second cylindrical chamber adjacent to said first chamber and extending downstream therefrom to an open end, said second chamber having a diameter that is wider than the diameter of the first chamber,
iii. an annular chamfered shoulder between said first chamber and said second chamber, and
iv. a second non-chamfered annular shoulder on an inside edge of the open end of said second chamber.

2. The combination of claim 1, wherein said second shoulder has a ninety degree cross section.

3. The combination of claim 1, wherein said opening further comprise a first pointed end at one edge of the dome, and a second pointed end at an opposite edge of the dome, and wherein the opening has a wide central area.

4. The combination of claim 1, wherein said shroud further comprises a mirror.

5. A combination showerhead nozzle and shroud comprising:
a. a nozzle body having an upstream end and a downstream end;
b. a flow passage disposed in said nozzle body, said flow passage having an inlet generally towards said upstream end and an elliptical outlet at said downstream end, said flow passage adapted to carry a liquid flow stream;
c. a pin extending across said nozzle body in parallel with said elliptical outlet;
d. a first flange defining a first edge of said elliptical outlet, said flange forming a first portion of a dome having a flattened ellipsoid shape for inducing turbulence into a first portion of said liquid flow stream;
e. a second flange defining a second edge of said elliptical outlet, said second flange forming an opposite second portion of said dome and also having a flattened ellipsoid shape for inducing turbulence into a second portion of said liquid flow stream such that said first stream and said second stream collide together to form a substantially uniform droplet sized spray; and
f. a hollow cylindrical shroud operable for engagement with said nozzle body such that an open end of said shroud extends out beyond the downstream end of said nozzle body, said shroud further comprising:
i. a first cylindrical internal chamber adjacent to said nozzle body, said first chamber having a diameter that corresponds to the diameter of said nozzle body,
ii. a second cylindrical chamber adjacent to said first chamber and extending downstream therefrom to an open end, said second chamber having a diameter that is wider than the diameter of the first chamber,
iii. an annular chamfered shoulder between said first chamber and said second chamber, and
iv. a second non-chamfered annular shoulder on an inside edge of the open end of said second chamber.

6. The combination of claim 5 wherein said outlet further comprises a first pointed end at a first edge of the nozzle, and a second pointed end at an opposite edge of the nozzle, and wherein the outlet has a wide central area.

7. The combination of claim 5 wherein the second annular shoulder has a ninety degree cross section.

8. The combination of claim 5 wherein said shroud further comprises a mirror.

9. A method for providing large droplets for showering without mist comprising the steps of:
a. contacting a first portion of a stream of water with the interior surface of a first curved flange of a nozzle body, said first flange having a flattened ellipsoid shape to deflect and induce turbulence into said first portion of said stream of water;
b. contacting a second portion of said stream of water with the interior surface of a second curved flange of said nozzle body, said second flange having a flattened ellipsoid shape to deflect and induce turbulence into said second portion of said stream of water;
c. contacting a third portion of said stream of water with a pin extending across said nozzle body to induce turbulence into said third portion of said stream of water;
d. forming atomized water droplets from the collision of said first second and third deflected portions of said stream of water;
e. passing said atomized water droplets through an elliptically shaped opening in said nozzle body, said opening being located between said first and second flanges;
f. passing said atomized water droplets into a first chamber of a shroud that is engaged with and downstream from said nozzle body to compress said water droplets;
g. passing said compressed droplets into a second chamber of said shroud that is attached to said first chamber, said second chamber having a diameter that is larger than a diameter of said first chamber to expand said droplets;
h. passing said expanded droplets through an end of said second chamber forming a uniform cone-shaped spray of large water droplets wherein an interior annular shoulder at the end of said second chamber has a non-chamfered surface to reduce the formation of mist.
